(19) United States
(12) Patent Application Publication
(10) Pub. No.: US 2018/0285946 A1
(43) Pub. Date: Oct. 4, 2018

(54) User-Tailored Social Business Review Network and System

(71) Applicants: Juan Carlos Figueredo, New York, NY (US); Manuel E. Figueredo, Washington, DC (US); Danielle M. Suber, Washington, DC (US)

(72) Inventors: Juan Carlos Figueredo, New York, NY (US); Manuel E. Figueredo, Washington, DC (US); Danielle M. Suber, Washington, DC (US)

(21) Appl. No.: 15/476,138

(22) Filed: Mar. 31, 2017

(51) Int. Cl. G06Q 30/02; G06Q 50/00; G06Q 50/12

(52) U.S. Cl. CPC G06Q 30/0282; G06Q 50/12; G06Q 50/01

(57) ABSTRACT

A peer-based social rating & review network and system is shown. The system employs a mobile device application and website in communication with a secured server computer, which facilitates the creation and viewing of ratings & reviews made by other users. Reviews displayed to a given user are limited by the user, who must manually select other users to follow. Users are followed according to their relationship to the user, as well as their belief in the legitimacy of their opinion. Reviews are based on elements which the reviewer directly experienced, such as a menu item purchased or service received, which limit the reviewer to provide input relating only to that which the reviewer personally experienced. Each user views unique restaurant ratings, as the ratings shown are the result of the manually selected fellow users that each user opts to follow based on taste.

### FIELD OF THE PRESENT INVENTION

The present invention relates to social ratings & review systems, and more specifically relates to a peer-based business rating & review social network configured to permit users to tailor review search results based on user-selected peers to follow, with ratings & reviews oriented to individual services or menu items (users score the particular individual menu items which in turn populates a general rating for the restaurant that is the result of the average of the rated dishes) of the business. The network is facilitated by a computer or mobile device in communication with secured network servers.

### BACKGROUND OF THE PRESENT INVENTION

Collective online reviews of businesses are known to exist, and can be found easily with cursory internet search. However, if a person wishes to seek ratings & reviews of a specific food item or service of a business, it is often more difficult to find reliable information, as the reviews collected by Facebook™ reviews or Yelp™ fail to provide the option to search ratings & reviews pertaining to a specific menu item or available service. Instead, they provide the faculties to permit users to review a business as a whole. This information is often irrelevant to future customers seeking information about a menu item which was not covered by available reviews (the information can also be considered irrelevant because it is taking into account thousands of general reviews that are not necessarily aligned with the tastes and preferences of the searching party, moreover, everyone sees the same rating scores and reviews in these existing services, instead of seeing ratings calculated as a result of the people followed).

Additionally, the social reviews provided by online services such as Yelp™ and Facebook™ are aggregated from all users who have provided a review. The overall score of businesses on such sites are generated based on an average of the overall scores/rating of the individual business. As such, while users are permitted to provide a rating based on the food and/or service that was received, this data has little effect on the aggregated score of the business. As the aggregate score for each business is generated based on every single user who has reviewed the establishment, the user seeking reviews is often misled by reviews that were purchased (essentially paid endorsements masquerading as legitimate reviews), and were made by unappreciated celebrities or opinions of other individuals which the user does not care for.

If there were a way that a user seeking ratings & reviews would only be shown ratings & reviews from reviewers that are trusted and known, such as friends, family, or appreciated celebrities, the ratings & reviews would be more pertinent and applicable than those shown that are aggregated from unknown users which may have been paid for their review. Likewise, if there were a network by which users could be provided ratings & reviews based on individual menu items, services, or products, reviews produced via a search would yield more pertinent data to the user.

Thus, there is a need for a new rating & review network, system, and construct by which users may share and view ratings & reviews from user-selected peers, groups, and celebrities, which review individual products, menu items, and goods based on their direct experience with the business. Reviews in such a system are preferably aggregated according to individual items, providing for a more accurate review experience. Users select friends, family, and known celebrities (or other reputable personalities) according to their perceived value relating to reviews. As such, users of such a service may only opt to see reviews from people who the user considers trustworthy and accurate. This directly contrasts with existing review systems on the market, which do not automatically show users only reviews from other users who are manually selected by the user, nor do present review systems provide more accurate results by basing review aggregate scores on individual items.

Such a system is preferably equipped with a user interface which is preferably facilitated via a website and mobile device application disposed in communication with a secured server computer. The secured server computer preferably stores the ratings & reviews provided by the users, and hosts the interface facilitating creation and viewing of the reviews.

### SUMMARY OF THE PRESENT INVENTION

The present invention is a social, peer-based rating & review platform equipped with a mobile device application component and a website component. The system of the present invention enables users to craft and view ratings & reviews of establishments such as restaurants, service providers, and small businesses directed towards specific items and products provided by the specific establishment. As such, users are provided the option to review a specific menu item of a specific establishment, rather than providing an overall review score of the establishment. Users wishing to view ratings or reviews written by other users are prompted to select the specific item of which he or she wishes to receive reviews from a list of available menu items. Users search the specific restaurant they are interested in learning the rating for, and they can see what specific dishes were rated that gave the restaurant that score. Additionally users also see the ratings on the TidFeed (NewsFeed) of the present invention, or when they use the other features of the application of the present invention, including the filters, the map, or view someone's profile, which stores all the restaurants they have been to, as well as their corresponding ratings.

Additionally, the system of the present invention relies on a social component, by which users select which other users they wish to follow, and therefore only read (are shown) reviews and ratings written by those users which he or she follows. User may opt to manually select fellow users to follow, or they may automatically compiled by linking another social network account of the user, such as from Facebook™, Twitter™, Instagram™, or other known social network with a compatible API. In such cases, the user is shown a list of known contacts (friends, family) which are presently a member of the system of the present invention, whereby the user may select which known users he or she wishes to follow on the platform of the present invention.

Likewise, users may opt to follow chefs and celebrities who have opinions that are valuable to the user. This manual selection prevents the user from being shown reviews that he or she does not value, either because the user disagrees with his or her taste, or because the reviews of some users may be sponsored content. This is also helpful to users, as they are shown ratings and reviews of places they would be more interested in going to, because the pool of ratings and reviews that is being generated by the present invention will likely match the user's neighborhood/cities, budget, taste, and cuisine preferences. Users are only shown reviews from fellow users of which the user has opted to follow by default. Users are also shown individual reviews/ratings in the TidFeed (a home screen of the mobile device application of the system of the present invention), but can also search for specific reviews using the filter or the explore features.

### BRIEF DESCRIPTION OF THE DRAWINGS

The present invention will be better understood with reference to the appended drawing sheets, wherein:

FIG. 1 exhibits a view of the mobile device application TidFeed interface of the mobile device application present invention.

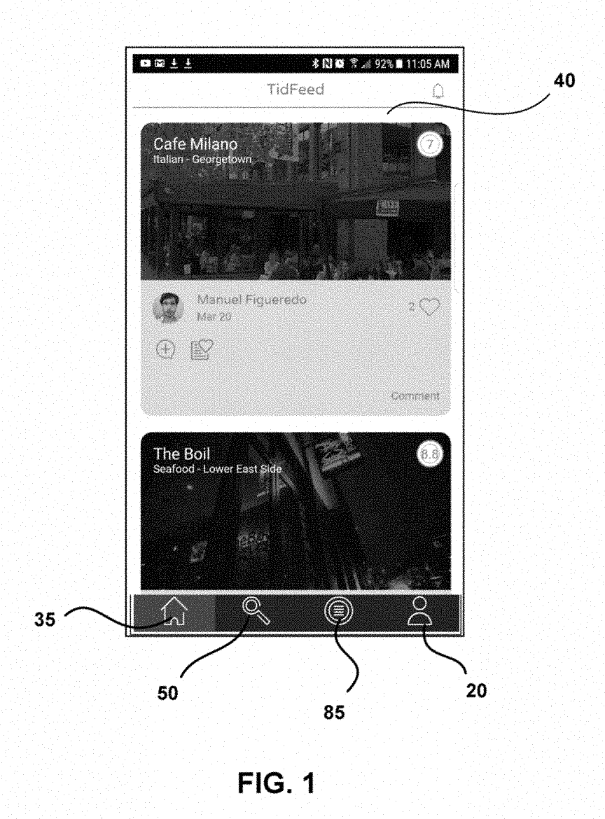

FIG. 2 displays a flowchart depicting the process of installation and use of the present invention from the viewpoint of a user.

FIG. 3 depicts a flowchart detailing the process of rating/review creation via the system of the present invention.

FIG. 4 exhibits a screenshot of the restaurant profile page of the mobile device application of the present invention.

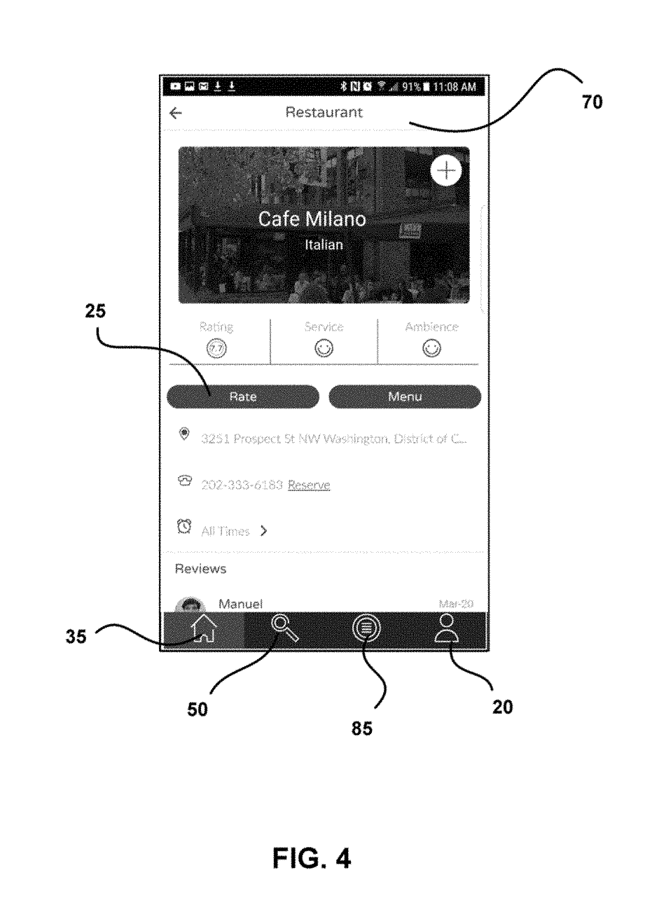

FIG. 5 shows a screenshot of a menu page of a restaurant of the mobile device application of the present invention.

FIG. 6 depicts a rating page of a restaurant for a specific menu item shown on the mobile device application of the present invention.

FIG. 7 exhibits a rating detail page of a restaurant shown via the mobile device application of the present invention.

FIG. 8 depicts the map feature of the mobile device application of the present invention.

### DETAILED DESCRIPTION OF THE PREFERRED EMBODIMENT

The present invention is a peer-based social rating & review system and network for use by users seeking to view or create reviews pertaining to a specific item or service of a specific business—namely, a restaurant. The present invention includes a mobile device application (10) and a website platform.

Unlike other social rating & review systems on the market today, the system of the present invention applies a user-tailored filter on all available reviews, which displays only pertinent and respected opinions to the user which are in accordance with the users follow list. Upon the creation of a user account by the user, the user is prompted to select fellow users having reputable opinions of which the user values. The user is encouraged to follow friends, family, and other users who maintain similar tastes to that of the user. Other users may include well-known celebrities, food critics, and chefs which are regarded as reputable and accurate in the eyes of the user. Followed users, as well as the selected username of the user are preferably displayed on a user profile page accessible from any screen via a profile icon (20).

The system of the present invention is preferably supported by at least one secured server computer, which serves to host the website platform, as well as the mobile device application (10) of the present invention. The at least one secured server computer preferably houses the reviews, facilitating access to the reviews when a relatable search term is entered by a user.

The interface (40) of the present invention, shown on both the mobile device application and the website platform, is preferably equipped with a search bar (50) to be used by a user wishing to perform a search for reviews of a specific dish or service of a specific establishment. It is envisioned that the search bar (50) may also be used to search for other users which the user is seeking to follow. The interface (40) includes a home menu to facilitate navigation, which depicts a TidFeed. The Search bar (50) or Explore function is also used to search for Restaurants, either to rate them, or to see what rating they have achieved (rating of that particular searched restaurant being the average of the ratings given to that particular restaurant by the people the user follows. A home button (35) preferably facilitates a return to the TidFeed from any screen.

During the creation of a rating/review by a user, the user is asked to rate a specific menu item which the user has experienced personally. As such, users rate the food or service experienced, rather than the entirety of the establishment itself. Users may be shown an overall rating of the restaurant or other establishment, however the novelty of the system of the present invention lies in the ratings of the food or other individual items themselves. Ambiance and service may also be rated, however ratings of the food or other items are favored and are weighted accordingly When a user navigates to a profile of a specific restaurant, referenced as restaurant profile (70), to check out its reviews/rating, three different scores are shown:
1. A Restaurant Rating, which has a numerical value between 1 and 10, this value is the result of the average rating each user gave the restaurant, and those individual ratings that make the average are the result of the average of the dish scores.
2. A Service Rating, by which users rate service either a 1 star (poor) 2 star (good) 3 star (excellent) scale.
3. Ambience, the same scaling system of 1-3 is applied. Thus users see three different scores when they see a restaurant review, higher emphasis is given to the restaurant rating which is the only one that has a numerical value). Ambiance may also be related to décor.

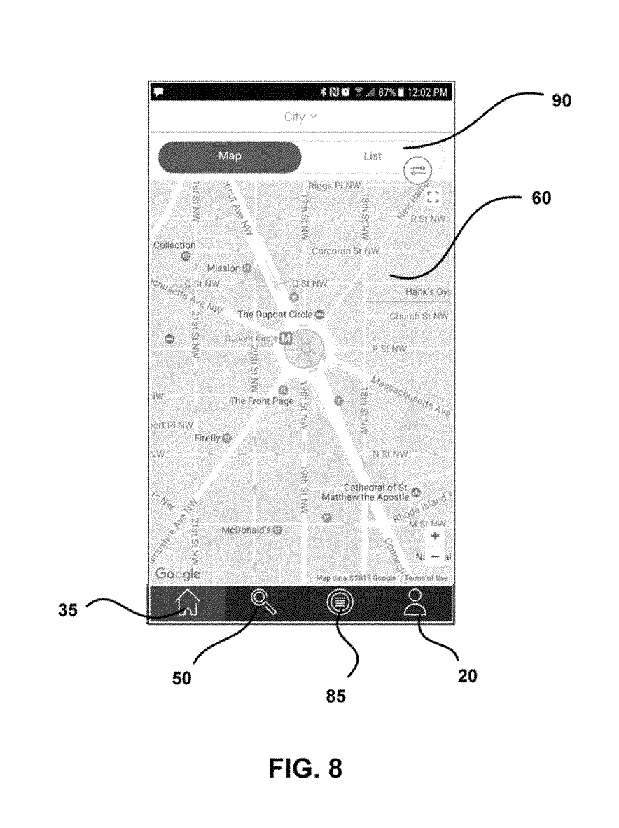

An additional feature of the interface (40) of the present invention is a map feature (60), which displays all of the places that have been rated by followed users within the geographical location selected. Again, only locations that have been reviewed by followed users are displayed on the map feature (60). The map feature (60) is accessible via a map button (85). An example of an embodiment of the map feature (60) of the present invention is shown in FIG. 8. A list button (90) is preferably present within the map feature (60) screen, which enables a user to view a list of proximal reviewed restaurants within the range of the view of the map feature (60). At least one filter may preferably be applied to the list view, including a neighborhoods filter, a cuisine filter, a rating filter, a price filter, and a visited filter.

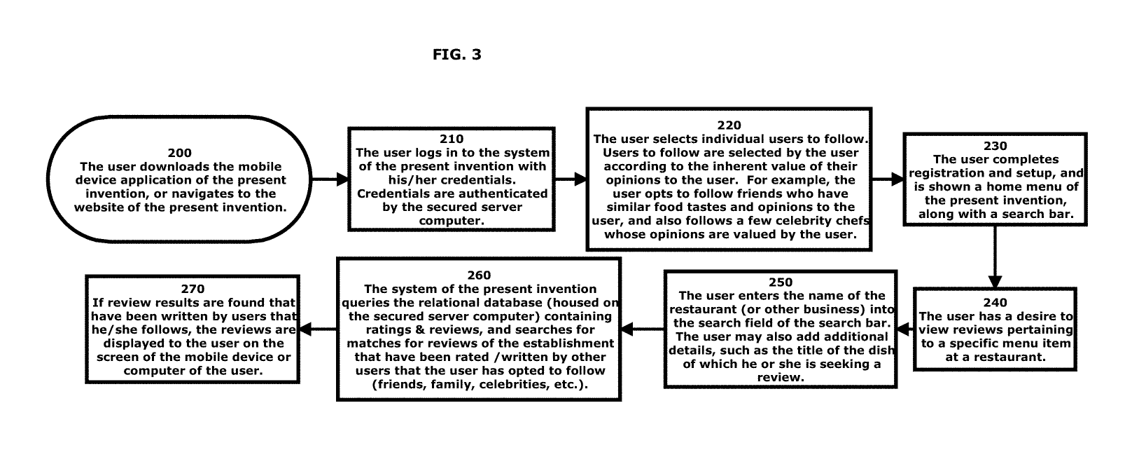

The process by which users may create a rating and review, as shown in FIG. 3, is preferably as follows:

1. First, a user searches for a restaurant which they wish to review and rate using the Explore tab, shown as the search bar (50) of the present invention. (100)

2. After selecting the appropriate restaurant to be rated, the Restaurant's profile is displayed on the screen of the mobile device. (110)

3. The user presses the ‘Rate’ button on the Restaurant's profile. (120)

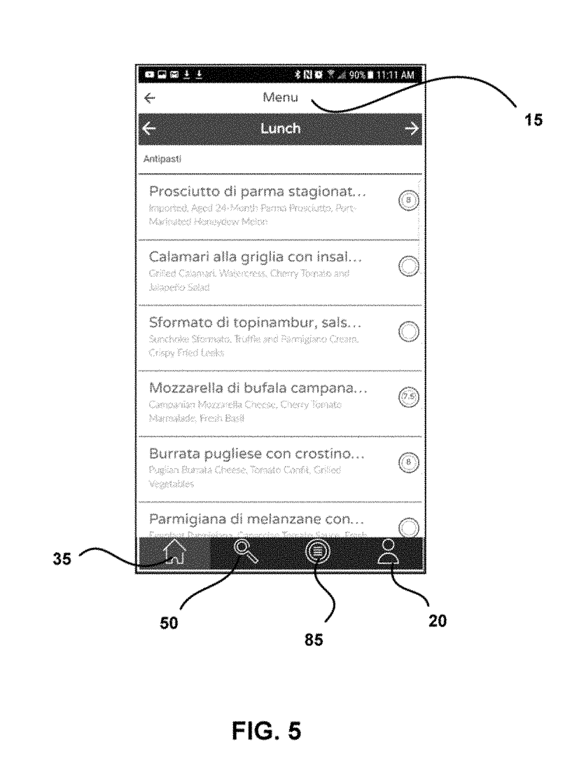

4. Upon pressing the ‘Rate’ button, the user is taken to the menu of the restaurant, on which each dish/menu item is displayed according to their respective category. Each menu item has a plate button next to the item name. The user taps on each plate button corresponding to the menu items he or she tried/wishes to rate. (130) The user may alternately search for the specific menu item, and tap the plate button to select the dish, as shown in FIG. 5. The plate buttons are effectively conventional radio buttons shaped as plates.

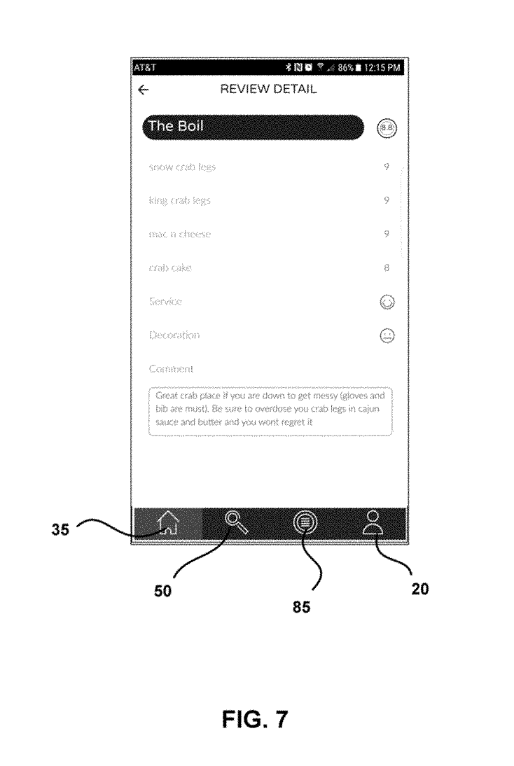

5. Once all of the menu items have been selected, the user presses a ‘next’ button, and is taken to a ‘Rating’ page (75) on which each menu item is displayed with a rating slider bar (45). The user slides his or her finger along the rating slider bar (45) to select the desired rating score (numerical value). (140) The numerical rating applied via the rating slider bar (45) is preferably between one and ten. A detail rating page, as shown in FIG. 7, shows additional details as to how the selected restaurant has earned the shown rating, comprised as an average of rated dishes.

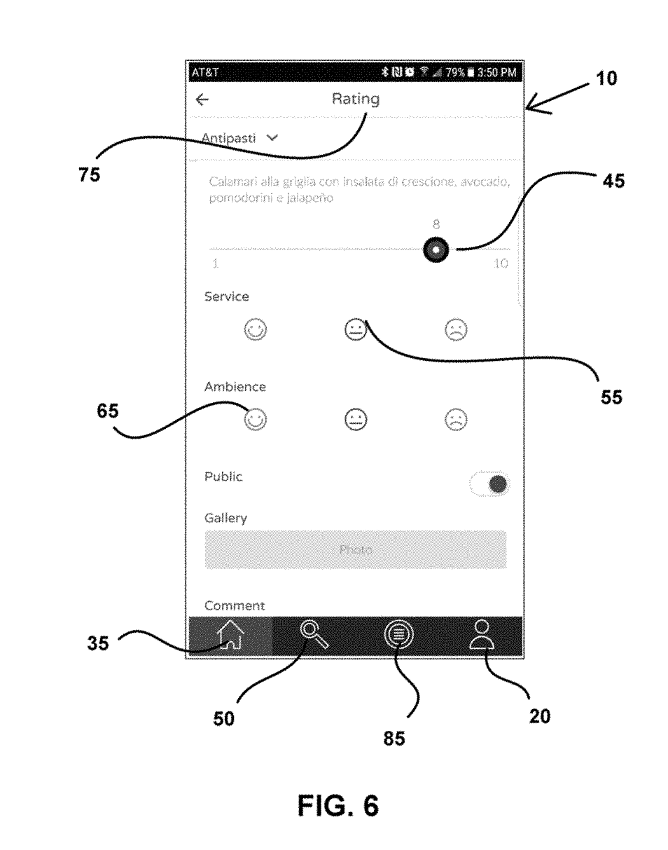

6. After rating the menu items, the user rates service via a service rater (55) by tapping on one of three options: one star, two stars, or three stars. (150) Alternately, happy face, neutral face, or sad face may represent values between one and three, as shown in FIG. 6.

7. Next, the user is prompted to rate the ambiance via an ambiance rater (65) as one star, two stars, or three stars. (160) Next, the user may opt to share their rating/review on the TidFeed (set to default) or to not share the rating/review on the TidFeed. (170) If the user opts not to share the rating/review to the TidFeed, the user's review will not appear on the newsfeed, but will still appear in their “my restaurants” section of the user's profile, and will be included in an average of the rating for that particular restaurant. The purpose of opting not to share to the TidFeed is if the user wants privacy, and therefore doesn't want their followers to immediately know where he/she ate.
8. Next, the user is provided the option to upload a picture of any or all of the menu items rated/reviewed by the user. (180) This step is optional.
9. Then, the user is provided the option to write a comment relating to the menu item(s), which can include a detailed personal review of the menu item or of the experience in general. (190)
10. After completion of the comment, the user presses a ‘rate button’ (25) at the bottom of the screen, and the review is generated/posted. The review then appears on the TidFeed (if the option was left selected as default), and will be taken into account by the user's followers who choose to check this particular restaurant's profile. (195)

In short, the user is prompted to review the following elements of the restaurant experience:
1. The dishes experienced.
2. Service encountered.
3. The ambiance of the restaurant.
4. To upload a photo of the menu item(s). (optional)
5. To provide a detailed comment of the experience. (optional)

It should be noted that if a user is rating a dish/menu item that he or she has previously rated, the new dish score is updated to replace the old one, but the old one score is still stored within the database of the present invention. When a user needs/wants to see the information for a restaurant's rating/review, the algorithm of the present invention identifies which users that user follows in order to determine the valid dishes that can be taken into account to populate a rating for that user depending on the people the user follows, and the ratings those users have given to the restaurant being searched. If the user searching for reviews/ratings of a restaurant has already reviewed the restaurant, his or her ratings are also taken into account in the restaurant's general rating.

As previously indicated, the menu items of a restaurant to be reviewed are selected by the user from a list or drop-down menu equipped with radio buttons to facilitate the selection of appropriate menu items. The system of the present invention is preferably in communication with a menu service system, such as SinglePlatform's API, which provides the system of the present invention access to menus of a large number of restaurants. If a user wishes to rate and review a signature, temporary, or ‘dish of the day’ menu item, the user is preferably afforded the option to manually type the name of the dish for review. Numerical ratings of each menu item are shown on a menu page (15) as shown in FIG. 5.

It should be understood that the highest rating score a restaurant may achieve via the system of the present invention is a rating of ten. However, the score of the restaurant, as well as individual dishes served by the restaurant, is prone to change as more users rate the restaurant and dishes. For example, if Restaurant-X has initially earned a rating of ‘10’ when a user views its restaurant profile, the user may tap the score of ‘10’ to see why it has earned that score. Once the user taps the ‘10,’ the application of the present invention displays the ratings that have been averaged to make it be that number. Say that, in this case, only two people the user follows have rated Restaurant-X: User1 had the zucchini and gave it a score of ‘ten,’ and also had the tiramisu, and gave it a score of ‘ten.’ Restaurant-X's rating for User1 is a ten because the average of both dishes he tried is still a ten. User2 also went to Restaurant-X to have the Zucchini and awarded it a score of ‘ten,’ but he also had the Burrata, and gave it a rating of ‘ten,’ and the Caprese and gave it a rating of ‘ten.’ Thus, for User 2, Restaurant-X is also afforded a score of ten. Now, if a user only followed those two users (user1, and user2), when the user views the restaurant profile of Restaurant-X, the user will see a rating of ‘ten’ for its rating. However, if the user started following User3, and User3 had also rated Restaurant-X, the score of the restaurant, based on the average score from followed users will change.

Continuing with the example, User 3 had the Zucchini and gave it a rating of ‘seven,’ and had the Tiramisu and gave it a rating of ‘ten.’ User3's rating score for Restaurant-X would therefore be an 8.5. Now that the user is also following User3, when the user views the Restaurant profile of Restaurant-X to see the rating, it no longer shows as a ‘ten’ in the profile, but as a 9.5 ((10+10_8.5)/3). The good thing is, the user may opt to tap on the 9.5 score and see that it is a 9.5 because User1 gave it a 10, User2 gave it a 10, and User3 gave it an 8.5. Effectively, the user may find out how and why Restaurant-X has earned the score. If the user wants to know why User3 gave it an 8.5, the user can click on the numbered rating of 8.5, and the mobile device application of the present invention will show that the score of 8.5 is the result of a ‘7’ rated Zucchini and a ‘10’ rated Tiramisu.

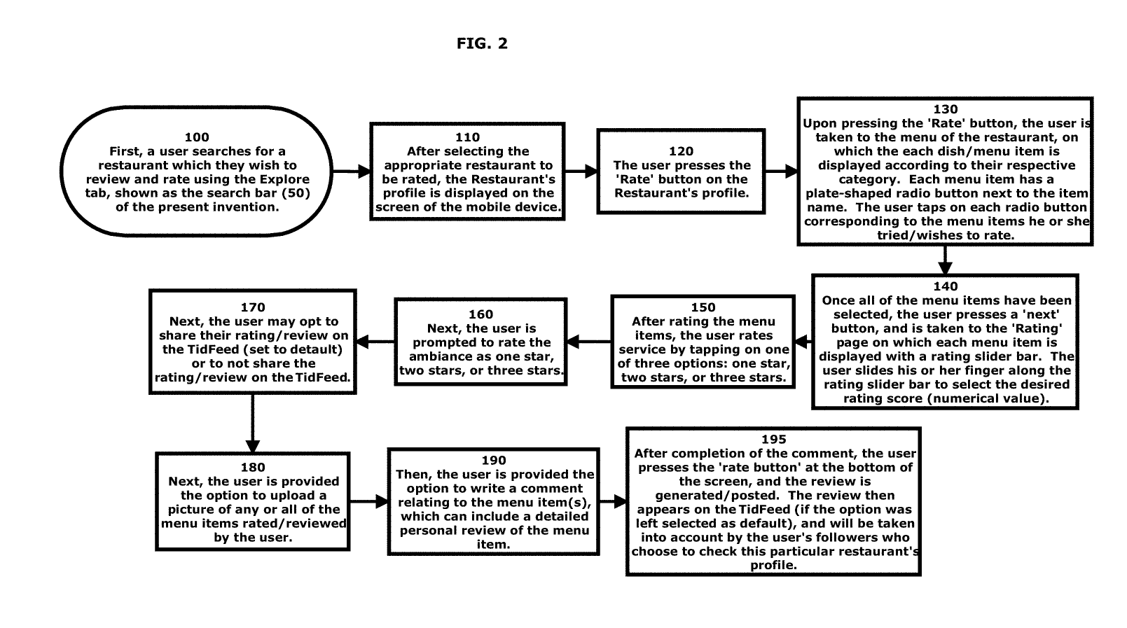

The process of installation and use of the present invention, as depicted in FIG. 2, is preferably as follows:

1. The user downloads the mobile device application of the present invention, or navigates to the website of the present invention. (200)

2. The user logs in to the system of the present invention with his/her credentials. Credentials are authenticated by the secured server computer. (210) If the user does not yet have an account, the user is prompted to create an account, including a username and password if applicable.

3. The user selects individual users to follow. Users to follow are selected by the user according to the inherent value of their opinions to the user. For example, the user opts to follow friends who have similar food tastes and opinions to the user, and also follows a few celebrity chefs whose opinions are valued by the user. (220) This step may be facilitated by linking the Facebook™, Twitter™, or other social network to the system of the present invention via their respective APIs. Additionally, users may opt to import contacts from their contacts list of the mobile device, which may help to get the user started with a base number of friends and family to follow who also have accounts with the system and network of the present invention.

4. The user completes registration and setup, and is shown a home menu of the present invention, along with a search bar. (230) The Home Menu is referenced as a ‘TidFeed.’ On the TidFeed, users are shown the individual reviews posted by other followed users. The TidFeed may be accessed at any time via the home button (35).

5. The user has a desire to view reviews pertaining to a specific menu item at a restaurant. (240)

6. The user enters the name of the restaurant (or other business) into the search field of the search bar. The user may also add additional details, such as the title of the dish of which he or she is seeking a review. (250)

7. The system of the present invention queries the relational database (housed on the secured server computer) containing ratings & reviews, and searches for matches for reviews of the establishment that have been rated/written by other users that the user has opted to follow (friends, family, celebrities, etc.). (260)

8. If review results are found that have been written by users that he/she follows, the reviews are displayed to the user on the screen of the mobile device or computer of the user. (270)

If no results are found, the user is provided the option to view any other reviews of the establishment relating to the specific menu item or detail provided by the user in alternate embodiments of the present invention. Preferably, the score is based only on those users that are followed and have rated/reviewed items at the establishment. This is in contrast with conventional review apps, with allow for users to select other users to follow, but overall review scores are shown as a global aggregate of users' opinions. The map feature (60), shows restaurants within proximity to the user. Next to each restaurant shown on the map feature (60), the average rating of the restaurant (as reviewed by followed users) is displayed. The map feature (60) is preferably accessible from any screen via the map button (85).

Alternative embodiments of the present invention may include additional features such as an alert mechanism, by which the user may be alerted to the existence of a new review that has been written by a followed user pertaining to an establishment that the user has searched for reviews relating to the establishment, but previously had no reviews made by followed (trusted) users.

It should be noted that, upon a user creating a user account, the present invention is configured to have the user automatically follow at least one other user, preferably founders of the system of the present invention, as well as bloggers of the city in which the application of the present invention is used. Users will be notified when they download the mobile device application (10) that they are now following these default user accounts while they build their personal network. The automatic following of these few users ensure that the new user does not see a blank application, such as on the TidFeed. The user is informed that he or she is welcome to unfollow these users if they desire, or if their tastes are not aligned. In the event that the user does not wish to follow any other user, only his or her own posts will be shown in his or her TidFeed, as well as potential advertised posts.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A system for rating a restaurant's individual menu items by a user comprising:
a mobile device application, said mobile device application running on a network-connected mobile device of the user;
a secured server computer, said secured server computer in communication with said mobile device application;
wherein said mobile device application facilitates the user following fellow users;
a home screen of the mobile device application, said home screen depicting a TidFeed;
wherein said TidFeed contains recently produced menu item ratings exclusively made by followed users;
a database, said database housed within said secured server computer;
wherein said database contains said recently produced menu item ratings;
wherein said recently produced menu item ratings are returned from said database, and displayed on said TidFeed if said recently produced menu item ratings are written by followed users and match a menu item selected by the user;
a restaurant profile page, said restaurant profile page configured to display an average of all ratings exclusively made by followed users on all menu items provided by the restaurant;
a restaurant menu page, said restaurant menu page configured to display all menu items available via the restaurant;
wherein said menu items are associated with a menu item rating depicted numerically adjacent to a title of each menu item;
wherein said menu item rating has a value between one and ten; and
a rating page, said rating page configured to facilitate rating of at least one menu item, service, and ambiance by the followed users to be shown exclusively to the user who has opted to follow the followed users.

2. The system of claim 1, further comprising:
a map feature, said map feature configured to display only restaurants that have been rated by followed users that are present within the range of a displayed street map.

3. The system of claim 2, further comprising:
a list feature, said list feature configured to display a list of restaurants that have been rated by followed users available within a range set by said map feature; and
wherein said list of restaurants are returned by said database upon the user navigating to said list feature within said mobile device application.

4. A method for viewing user-tailored menu item ratings of restaurants via a mobile device application comprising:
downloading the mobile device application to a mobile device;
running the mobile device application on the mobile device;
the mobile device application connecting the mobile device to a secured server via a network;
establishing a user account on the mobile device application;
wherein the user account includes a username and a password as credentials;
logging into a network-based service of the mobile device application with the credentials;
manually selecting fellow users to follow based on food tastes, familiar relation, and friendships;
the secured server forming a database of menu item ratings accessible via the mobile device application;
the secured server saving the database of menu item ratings;
the mobile device application searching the database for menu item ratings only pertaining to a specific menu item from various restaurants as indicated by the user;
the database returning menu item ratings only relating to the specific menu item indicated by the user for the various restaurants;
the mobile device application ordering the menu item ratings such that most recently reviewed menu item ratings from the various restaurants appear first;
the mobile device application displaying a TidFeed home screen on the mobile device;
the TidFeed home screen displaying results of the most recently reviewed menu items from the various restaurants produced by followed fellow users exclusively which were returned from the database; and
the mobile device application selecting a specific menu item from a list of menu items from a restaurant to receive reviews from followed fellow users.

5. The method of claim 4, further comprising:
the mobile device application searching for rating information pertaining to a desired restaurant;
navigating to a restaurant profile of the desired restaurant; and
the restaurant profile displaying rating information numerically as an average of all ratings of all menu items produced by followed fellow users exclusively.

6. The method of claim 5, further comprising:
the mobile device application searching the database for information pertaining to an individual menu item from the desired restaurant;
the database returning results displayed on the mobile device application;
selecting the individual menu item from the results containing a list of menu items shown on the mobile device via the mobile device application; and
viewing a numerical rating of the individual menu item derived from an average of ratings of the individual menu item made by followed fellow users exclusively.

7. The method of claim 5, further comprising:
rating an individual menu item from the desired restaurant after experiencing the individual menu item;
selecting a rate button shown on the restaurant profile;
the mobile device application displaying a menu of the desired restaurant in a list format;
wherein individual menu items of the menu may be manually selected by the user;
selecting the individual menu item which the user desires to rate;
selecting a next button, advancing the user to a rating screen;
the mobile device application prompting the user to rate the individual menu item on a scale of one to ten;
the user selecting an appropriate rating of the individual menu item between one and ten;
the mobile device application saving the rating made by the user to the secured server; and
the secured server including the rating into the average rating of the individual menu item for the rating displayed for the individual menu item to all fellow users who follow the user.

8. The method of claim 7, further comprising:
the user rating the ambiance of the restaurant at which the user experienced the individual menu item according to the experience of the user on a scale of one to three;
the user rating the service of the restaurant at which the user experienced the individual menu item according to the experience of the user on the scale of one to three; and
the mobile device application saving the service rating and the ambiance rating to the database housed on the secured server.

9. The method of claim 7, further comprising:
the mobile device application providing the user the ability to write a comment relating to the experience of the user with the desired restaurant;
the user writing a comment pertaining to the experience of the user with the desired restaurant; and
the mobile device application saving the comment to the database housed on the secured server.

10. The method of claim 8, further comprising:
the mobile device application providing the user the ability to write a comment relating to the experience of the user with the desired restaurant;
the user writing a comment pertaining to the experience of the user with the desired restaurant; and
the mobile device application saving the comment to the database housed on the secured server.

11. A method of reviewing and viewing reviews of menu items via a mobile device by a user comprising:
downloading a mobile device application to the mobile device;
searching for a specific menu item of interest via a search bar within the mobile device application;
the mobile device application communicating with a database, the database containing ratings of menu items;
the database returning results containing ratings of the menu item of interest which is offered by restaurants within a user-defined radius; and
the mobile device application displaying only results, shown as a list, which contain pertinent and respected opinions to the user which are in accordance with a follow list of the user.

12. The method of claim 11, wherein the results displayed only include those ratings which have been crafted by fellow users of the mobile device application which the user has opted to follow.

13. The method of claim 11, further comprising:
selecting a menu item from an establishment to rate based on a dining experience;
rating the menu item on a numerical scale;
the mobile device application conveying the rating to the database; and
the database relaying the rating only to fellow users who have opted to follow the user.
